(19) United States
(12) Patent Application Publication
(10) Pub. No.: US 2026/0328555 A1
(43) Pub. Date: Oct. 22, 2026

(54) THICKNESS VARIATION MEASUREMENT OF A GLASS WAFER WITH A FIZEAU INTERFEROMETER

(71) Applicant: KLA CORPORATION, Milpitas, CA (US)

(72) Inventor: Yuchi Chen, Sinagpore (SG)

(21) Appl. No.: 19/635,744

(22) Filed: Mar. 31, 2026

Related U.S. Application Data
(60) Provisional application No. 63/789,426, filed on Apr. 16, 2025.

(51) Int. Cl. G01B 9/02015; G01B 9/02; G01B 11/06

(52) U.S. Cl. CPC G01B 9/02027; G01B 9/02041; G01B 11/06

(57) ABSTRACT

Light is measured while directed through a first channel and a second channel toward a holding assembly without a transparent workpiece. Light is measured while the light is directed through the first channel and the second channel toward a transparent workpiece in the holding assembly while the light includes a periodic variation in wavelength, which shortens its coherence length. The transparent workpiece is then adjusted in the holding assembly so that a surface of the transparent workpiece is at an angle relative to a path of the light. The light is directed through the first channel and the second channel while the transparent workpiece is angled. A thickness variation of the transparent workpiece is then determined based on the three measurements.

### CROSS-REFERENCE TO RELATED APPLICATIONS

This application claims priority to the provisional patent application filed Apr. 16, 2025 and assigned U.S. App. No. 63/789,426, the disclosure of which is hereby incorporated by reference.

### FIELD OF THE DISCLOSURE

This disclosure relates to measuring thickness of a wafer through interferometry.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a semiconductor manufacturer.

Fabricating semiconductor devices, such as logic and memory devices, typically includes processing a workpiece like a semiconductor wafer using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etching, deposition, and ion implantation. An arrangement of multiple semiconductor devices fabricated on a single semiconductor wafer may be separated into individual semiconductor devices.

One measurement of workpieces, such as semiconductor wafers, is thickness. An interferometer can be used to determine the thickness of a semiconductor wafer or other workpiece by directing a coherent light beam onto the wafer surface and measuring the interference pattern generated by reflections from the front and back surfaces of the wafer. As the reflected beams recombine, the combined beams produce constructive and destructive interference based on the optical path difference between the two reflections, which varies with thickness. By scanning the workpiece or adjusting the wavelength and analyzing the resulting fringe pattern, the system can determine the physical thickness using optical interference relationships, typically accounting for the refractive index of the workpiece. However, current interferometers cannot be used to measure a glass wafer that does not have other layers deposited on its surface. There are multiple reflection sources in a glass wafer or other transparent workpiece that prevent accurate measurement, which may include front reference flat reflection, glass wafer front surface reflection, glass wafer back surface reflection, and back reference reflection.

Improved systems and techniques are needed.

### BRIEF SUMMARY OF THE DISCLOSURE

A method is provided in a first embodiment. The method includes directing light from a light source through a first channel and a second channel toward a holding assembly configured to hold a transparent workpiece (e.g., a glass wafer) and measuring the light in the first channel with a first detector and the second channel with a second detector during a first measurement. The transparent workpiece is disposed on the holding assembly. The light is directed through the first channel and the second channel at the transparent workpiece and measured the first channel with the first detector and the second channel with the second detector during a second measurement. The light includes a periodic variation in wavelength during the second measurement thereby shortening a coherence length. The transparent workpiece is adjusted on the holding assembly such that a surface of the transparent workpiece is in an angled orientation that is at an angle relative to a path of the light. The light is directed through the first channel and the second channel at the transparent workpiece while the transparent workpiece is in the angled orientation and measured in the first channel with the first detector and in the second channel with the second detector during a third measurement. Using a processor, a thickness variation of the transparent workpiece is determined based on the first measurement, the second measurement, and the third measurement.

The holding assembly may be without the transparent workpiece during the first measurement.

The transparent workpiece may not include an additional layer on the surface of the transparent workpiece.

The first channel and the second channel may each include a beam splitter and a reference flat.

The light from the light source may have a wavelength from ultraviolet to infrared.

A system is provided in a second embodiment. The system includes a holding assembly configured to hold a transparent workpiece (e.g., a glass wafer); a light source that generates light; a first channel that includes a first beam splitter, a first collimator, and a first reference flat that directs the light at the transparent workpiece on the holding assembly; a second channel that includes a second beam splitter, a second collimator, and a second reference flat that directs the light at the transparent workpiece on the holding assembly; a first detector that collects light from the first channel; a second detector that collects light from the second channel; and a processor in electronic communication with the first detector and the second detector. The processor is configured to receive a first measurement from the first detector and the second detector when the transparent workpiece is not present on the holding assembly; receive a second measurement from the first detector and the second detector when the light directed at the transparent workpiece includes a periodic variation in wavelength thereby shortening a coherence length; receive a third measurement from the first detector and the second detector when the transparent workpiece is at an angled orientation that is at an angle relative to a path of the light; and determine thickness variation of the transparent workpiece based on the first measurement, the second measurement, and the third measurement.

The transparent workpiece may not include an additional layer on the surface of the transparent workpiece.

The light from the light source may have a wavelength from ultraviolet to infrared.

The processor may be further configured to send instructions for the system to perform the first measurement, the second measurement, and the third measurement.

A non-transitory computer-readable storage medium is provided in a third embodiment. The non-transitory computer-readable storage medium includes one or more programs for executing the following steps on one or more computing devices. A first measurement from a first detector and a second detector of an interferometer is received when a transparent workpiece (e.g., a glass wafer) is not present on the holding assembly and light is directed through the interferometer. A second measurement from the first detector and the second detector of the interferometer is received when the light directed at the transparent workpiece includes a periodic variation in wavelength thereby shortening a coherence length. A third measurement from the first detector and the second detector of the interferometer is received when the transparent workpiece is at an angled orientation that is at an angle relative to a path of the light. Thickness variation of the transparent workpiece is determined based on the first measurement, the second measurement, and the third measurement.

The transparent workpiece may not include an additional layer on the surface of the transparent workpiece.

The light from the light source may have a wavelength from ultraviolet to infrared.

The steps may further include sending instructions for the interferometer to perform the first measurement, the second measurement, and the third measurement.

### DESCRIPTION OF THE DRAWINGS

For a fuller understanding of the nature and objects of the disclosure, reference should be made to the following detailed description taken in conjunction with the accompanying drawings, in which:

FIG. 1 is a block diagram of an embodiment of a system in accordance with the present disclosure;

FIG. 2 is a block diagram showing operation of part of the system of FIG. 1 in accordance with the present disclosure;

FIG. 3 is a block diagram showing operation of part of the system of FIG. 1 in accordance with the present disclosure; and

FIG. 4 is a block diagram showing operation of part of the system of FIG. 1 in accordance with the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

Interferometers, such as, for example, a dual Fizeau wavelength changing phase-shifting interferometer, can measure the shape and thickness variation of a semiconductor wafer or other workpiece. However, interferometers are limited when measuring thickness of a transparent workpiece, such as a glass wafer used as a carrier in advanced packaging. A glass wafer causes multiple reflections that affect measurements. Embodiments disclosed herein measure flatness of a transparent workpiece with a Fizeau interferometer. To analyze the interferograms, influence of some unwanted reflections can be eliminated. For the Fizeau interferometer, the reflections from the unwanted surface can be diverged away from the collection optics and interference of the unwanted reflections can be rendered unnoticeable in the collected interferograms.

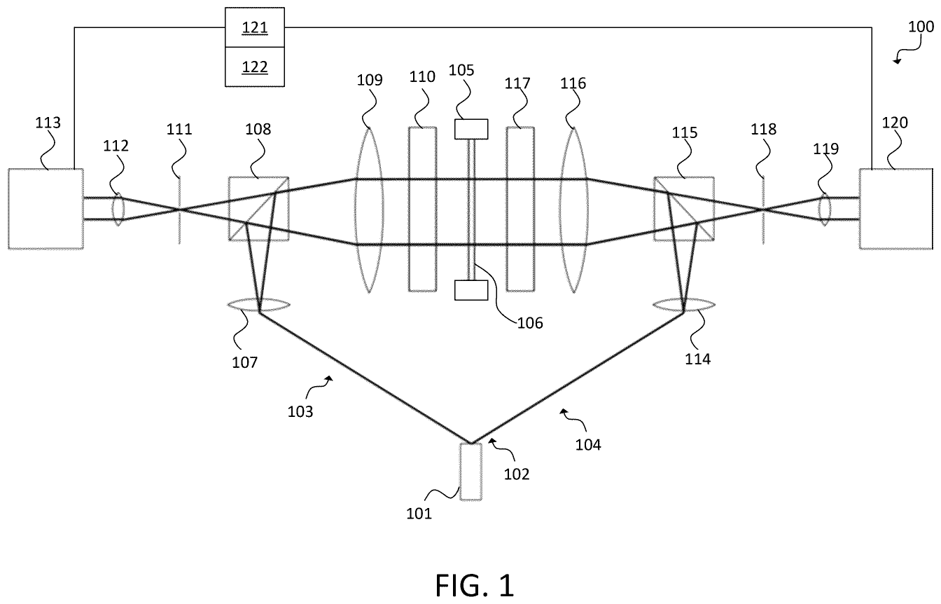

FIG. 1 is a block diagram of an embodiment of a system 100. The system includes a light source 101 that generates light 102. The light source 101 may be, for example, a laser. The light 102 from the light source 101 may have a wavelength from the ultraviolet to infrared range (e.g., wavelengths from 100 nm to 1 mm). The light source 101 may provide a coherent, monochromatic beam of light that enables the formation of stable interference fringes. For example, a long coherence length and narrow linewidth can ensure that the phase relationship between split beams remains well-defined as the split beams travel along different optical paths and recombine.

The system 100 directs the light into two channels. This includes a first channel 103 and a second channel 104. The components of the first channel 103 and the second channel 104 may be substantially the same. The first channel 103 and second channel 104 can provide a comparison of the phase difference between two coherent light beams. In an embodiment, a beam splitter can divide the incoming light 102 into the first channel 103 and second channel 104, which travel along different paths. Any difference in optical path length caused by displacement, surface irregularities, refractive-index changes, or material thickness may produce constructive or destructive interference when the beams of light 102 merge. By analyzing this interference pattern, the system 100 can determine information about the transparent workpiece 106. Thus, the first channel 103 and second channel 104 provide a reference path and a measurement path, enabling the system 100 to detect small changes in the transparent workpiece 106.

A holding assembly 105 is configured to hold a transparent workpiece 106 in the path of the light 102 of the first channel 103 and second channel 104. Examples of a transparent workpiece include transparent samples, such as a panel sample. The transparent workpiece 106 may be a glass wafer, such as a glass wafer. The glass may be borosilicate glass, fused silica, or quartz. Other materials for the transparent workpiece 106 can include quartz or sapphire under visible light or silicon under infrared light. In an instance, the transparent workpiece 106 may not have any films or other layers deposited on one or more of its surfaces, which can include a lack of films or other layers on any surfaces. In another instance, the transparent workpiece 106 may have films or other layers deposited on one or more of its surfaces. The holding assembly 105 is capable of tilting the transparent workpiece 106 about the axis that the light 102 is projected, which can use one or more motors. In an example, the holding assembly 105 holds the transparent workpiece 106 at three points. The outer surfaces of the transparent workpiece 106 may be minimally obscured by the holding assembly 105. The holding assembly 105 may hold the outer circumference of the transparent workpiece 106 or may hold part of the flat outer surfaces of the transparent workpiece 106.

The light 102 in the first channel 103 passes through a relay lens 107 and a beam splitter 108. The light 102 is directed through a collimator 109 and reference flat 110 before reaching the transparent workpiece 106. The light 102 that is reflected from the reference flat 110, reference flat 117, and/or transparent workpiece 106 is directed to the field stop 111 and relay objective 112. The detector 113 collects the light 102 from the first channel 103.

The light 102 in the second channel 104 passes through a relay lens 114 and a beam splitter 115. The light 102 is directed through a collimator 116 and reference flat 117 before reaching the transparent workpiece 106. The light 102 that is reflected from the reference flat 110, reference flat 117, and/or transparent workpiece 106 is directed to the field stop 118 and relay objective 119. The detector 120 collects the light 102 from the second channel 104.

In the system 100, the incoming light 102 from the light source 101 is directed through the beam splitter 108 to the collimator 109 or beam splitter 115 to the collimator 116. The collimated beam of light 102 propagates to the reference flat 110 or reference flat 117, whose last surface is the reference surface of the interferometer. The transparent workpiece 106 is placed between the reference flat 110 and reference flat 117 of the first channel 103 and second channel 104, such that both surfaces of the transparent workpiece 106 can be measured simultaneously. The beams of light 102 reflected at the surface of the transparent workpiece 106 and at the reference surface of the reference flat 110 or reference flat 117 propagate back through the collimator lens 109 or collimator 116, the beam splitter 108 or beam splitter 115, and the relay objective 112 or relay objective 119, which images the surface of the transparent workpiece 106 on the detector 113 or detector 120, where the interferograms are detected. The wavelength of the light source 101 may be varied to create a linear phase shift in the interferograms. Several frames of phase-shifted interferograms are collected, which are subsequently processed by the processor 121 to convert to optical path difference (OPD) between the surface of the transparent workpiece 106 and the surface of the reference flat 110 or reference flat 117 at each camera pixel. This interferogram includes the interference of light beams reflected from the reference flat 110, the transparent workpiece 106 surface facing a direction of the beam of light 102, the surface of the transparent workpiece 106 opposite the direction of the beam of light 102, and the reference flat 117.

The detector 113 and the detector 120 may be cameras or other imaging devices. A camera used in an interferometer like the system 100 may be a high-sensitivity imaging sensor like a CCD or CMOS device. The detector 113 and the detector 120 may be positioned to capture the interference fringes produced by a coherent light source. The detector 113 and the detector 120 may record the spatial pattern of constructive and destructive interference with sufficient resolution to enable analysis of phase shifts or fringe movement. The captured fringe images are then processed by the processor 121 to extract measurements such as displacement, surface profile, or thickness.

The detector 113 and the detector 120 are in electronic communication with a process 121. The term “processor” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the processor 121 may include any device configured to execute algorithms and/or instructions (e.g., program instructions stored in memory). In an embodiment, the processor 121 may be embodied as a desktop computer, mainframe computer system, workstation, image computer, parallel processor, networked computer, or any other computer system configured to execute a program configured to operate or operate in conjunction with the system 100, as described throughout the present disclosure. Moreover, different subsystems of the system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single processor 121 or, alternatively, multiple processors 121. The processor 121 may analyze data received from the detector 113 and the detector 120 and feed the data to additional components within the system 100 or external to the system 100.

A memory medium 122 associated with the processor 121 may include any storage medium known in the art suitable for storing program instructions executable by the associated one or more processors 121. For example, the memory medium 122 may include a non-transitory memory medium. By way of another example, the memory medium 122 may include, but is not limited to, a read-only memory (ROM), a random-access memory (RAM), a magnetic or optical memory device (e.g., disk), a magnetic tape, a solid-state drive and the like. It is further noted that memory medium 122 may be housed in a common housing with the one or more processors 121. In an embodiment, the memory medium 122 may be located remotely with respect to the physical location of the one or more processors 121. For instance, the one or more processors 121 may access a remote memory medium 122 (e.g., server), accessible through a network (e.g., internet, intranet and the like).

A user interface can be communicatively coupled to the processor 121. The user interface may include, but is not limited to, one or more displays, desktops, laptops, tablets, and the like. In embodiments, the user interface includes a display used to display data of the system 100 to a user. The display of the user interface may include any display known in the art. For example, the display may include, but is not limited to, a liquid crystal display (LCD), an organic light-emitting diode (OLED) based display, or a cathode ray tube (CRT) display. Those skilled in the art should recognize that any display device capable of integration with a user interface is suitable for implementation in the present disclosure. In embodiments, a user may input selections and/or instructions responsive to data displayed to the user via a user input device of the user interface.

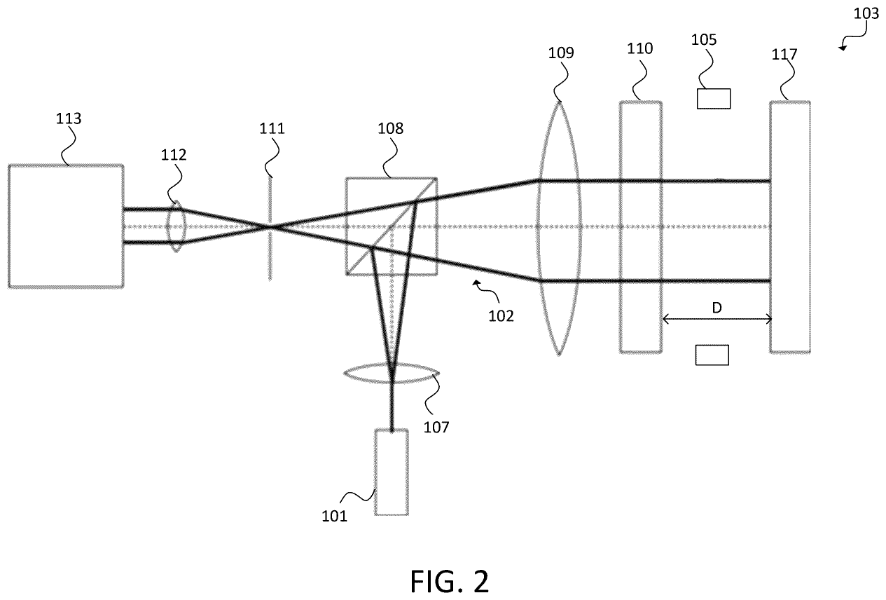

FIG. 2 is a block diagram showing operation of the system 100 of FIG. 1 during a first measurement (OPD₁). Only the first channel 103 of FIG. 1 is illustrated, but the operation of the second channel 104 can operate in a similar manner. During the first measurement, light 102 from the light source 101 is directed through the first channel 103 toward a holding assembly 105 configured to hold a transparent workpiece 106. The light 102 in the first channel 103 is measured with the first detector 113. As shown in FIG. 2, the holding assembly 105 does not hold a transparent workpiece 106 during the first measurement. A transparent workpiece 106 is not loaded on the holding assembly 105 during the first measurement.

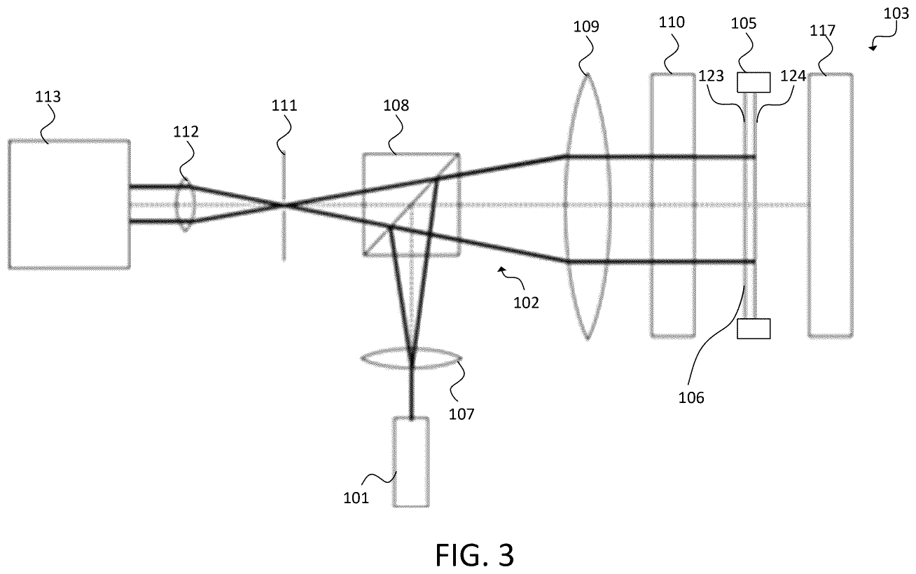

FIG. 3 is a block diagram showing operation of the system 100 of FIG. 1 during a second measurement (OPD₂). Only the first channel 103 of FIG. 1 is illustrated, but the operation of the second channel 104 can operate in a similar manner. In FIG. 3, the transparent workpiece 106 is disposed on the holding assembly 105. For example, the transparent workpiece 106 can be loaded in the system 100 onto the holding assembly 105 between the first measurement and the second measurement, such as with a robot. During the second measurement, the light 102 is directed through the first channel 103 at a transparent workpiece 106 on the holding assembly 105. The light 102 in the first channel 103 is measured with the first detector 113. The light 102 includes a periodic variation in wavelength during the second measurement thereby shortening a coherence length. The coherence length may be shorter than a distance from transparent workpiece 106 to the reference flat 110 so that there is no interference.

The second measurement can be used to eliminate influence of some unwanted reflections and make the interference caused by the unwanted reflections unnoticeable in the collected interferogram. For example, the coherence length of the light source 101 can be configured to achieve this effect. Besides wavelength variation of the light source 101 for the linear phase shift, a high frequency periodic variation can be added to the wavelength to shorten the coherence length of the light 102. This can eliminate the influence of the reference flat 110 and reference flat 117 in the thickness measurements.

As shown in FIG. 3, the distances from the reflecting surfaces of the reference flat 110 or reference flat 117 to the front surface 123 or back surface 124 of the transparent workpiece 106 are longer than the distance from the front surface 123 to the back surface 124 of the transparent workpiece 106 (i.e., the thickness of the transparent workpiece 106). Thus, the thickness of the transparent workpiece 106 is less than the distance between the transparent workpiece 106 and either the reference flat 110 or the reference flat 117. By controlling an amplitude of the high frequency periodic variation of the wavelength of the light 102, the influence of the reflections from the reference flat 110 and reference flat 117 can be eliminated. Thus, only the reflections from the front surface 123 and back surface 124 of the transparent workpiece 106 will interfere and result in an OPD.

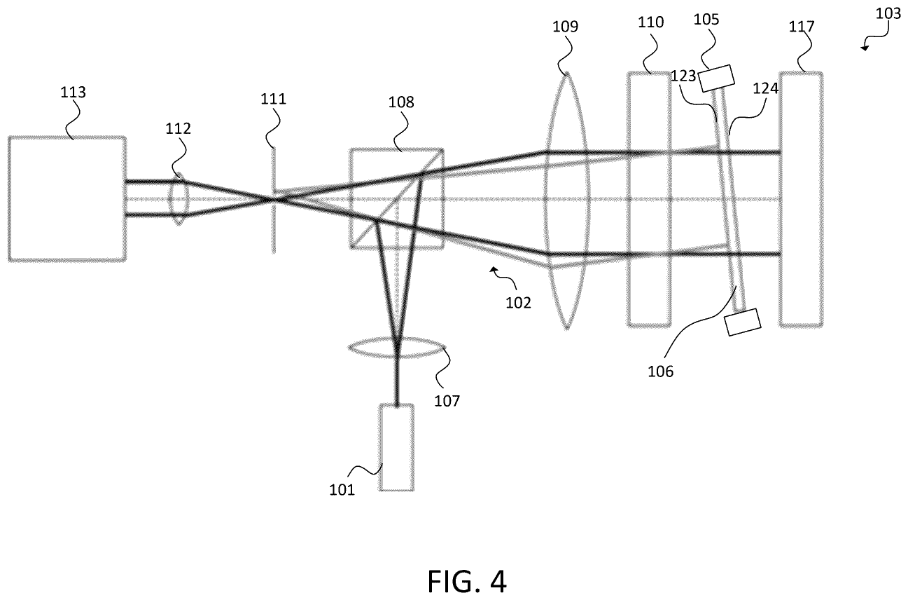

FIG. 4 is a block diagram showing operation of the system 100 of FIG. 1 during a third measurement (OPD₃). Only the first channel 103 of FIG. 1 is illustrated, but the operation of the second channel 104 can operate in a similar manner. In FIG. 4, the transparent workpiece 106 is disposed on the holding assembly 105. The transparent workpiece 106 is adjusted on the holding assembly 105 such that the surface of the transparent workpiece 106 is in an angled orientation that is at an angle relative to a path of the light 102. The angle of the angled orientation may depend on the numerical aperture of the optics. For example, the angle may be from 1° to 45° or from 1° to 60°, though other angles are possible. In an instance, the tilt angle is larger than the numerical aperture. In the third measurement, the light 102 is directed through the first channel 103 at a transparent workpiece 106 on the holding assembly 105. The light 102 in the first channel 103 is measured with the first detector 113.

Tilting the transparent workpiece 106 can diverge the reflections from the front surface 123 and back surface 124 of the transparent workpiece 106 because these reflections will be blocked by the field stop 111. This can eliminate the reflections from the front surface 123 and back surface 124 of the transparent workpiece 106. This is shown in FIG. 4 with some of the light 102 reflected from the transparent workpiece 106 being blocked at the field stop 111.

With OPD₂, OPD₃, and the obtainable distance D between the reference flat 110 and reference flat 117, the flatness of the transparent workpiece 106 can be determined. Turning back to FIG. 1, the processor 121 can be used to determine a thickness variation of the transparent workpiece 106 based on the first measurement, the second measurement, and the third measurement. The thickness T can be determined as

$$T = \frac{{OPD}_{3} + {OPD}_{1} - {OPD}_{2}}{2} .$$

In an instance, the thickness T may be at a particular point on the transparent workpiece 106. Such a thickness can be determined at two points on the transparent workpiece 106 to determine a variation or can be determined at more than two points on the transparent workpiece 106 to determine a variation across part of a surface of the transparent workpiece 106 or even an entire surface of the transparent workpiece 106. Thickness variation can be the difference in the thickness across part or all of a surface of the transparent workpiece 106. For example, the thickness variation can be measured as a maximum difference or average difference across part or all of the surface of the transparent workpiece 106.

While described in a particular order of steps, this is merely an example. The various measurements can be performed in other sequences than that described herein. Thus, the second and third measurements can be performed before the first measurement in an example. In another example, the sequence measures the first measurement, the third measurement, and then the second measurement. Other variations of the steps are possible.

An additional embodiment relates to a non-transitory computer-readable medium storing program instructions executable on a processor. In particular, a processor, such as the processor 121 in FIG. 1, can be coupled to a memory in an electronic data storage medium with non-transitory computer-readable medium, such as the memory medium 122, that includes executable program instructions. The computer-implemented method may include any step(s) of any method(s) described herein. For example, processor 308 may be programmed to perform some or all of the steps of method shown in FIGS. 2-4. The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (MFC), Streaming SIMD Extension (SSE), or other technologies or methodologies, as desired.

While described with a Fizeau interferometer, other interferometry systems can operate using the techniques disclosed herein.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A method comprising:
directing light from a light source through a first channel and a second channel toward a holding assembly configured to hold a transparent workpiece and measuring the light in the first channel with a first detector and the second channel with a second detector during a first measurement;
disposing the transparent workpiece on the holding assembly;
directing the light through the first channel and the second channel at the transparent workpiece and measuring the first channel with the first detector and the second channel with the second detector during a second measurement, wherein the light includes a periodic variation in wavelength during the second measurement thereby shortening a coherence length;
adjusting the transparent workpiece on the holding assembly such that a surface of the transparent workpiece to be in an angled orientation that is at an angle relative to a path of the light;
directing the light through the first channel and the second channel at the transparent workpiece while the transparent workpiece is in the angled orientation and measuring the first channel with the first detector and the second channel with the second detector during a third measurement; and
determining, using a processor, thickness variation of the transparent workpiece based on the first measurement, the second measurement, and the third measurement.

2. The method of claim 1, wherein the holding assembly is without the transparent workpiece during the first measurement.

3. The method of claim 1, wherein the transparent workpiece does not include an additional layer on the surface of the transparent workpiece.

4. The method of claim 1, wherein the transparent workpiece is a glass wafer.

5. The method of claim 1, wherein the first channel and the second channel each include a beam splitter and a reference flat.

6. The method of claim 1, wherein the light from the light source has a wavelength from ultraviolet to infrared.

7. A system comprising:
a holding assembly configured to hold a transparent workpiece;
a light source that generates light;
a first channel that includes a first beam splitter, a first collimator, and a first reference flat that directs the light at the transparent workpiece on the holding assembly;
a second channel that includes a second beam splitter, a second collimator, and a second reference flat that directs the light at the transparent workpiece on the holding assembly;
a first detector that collects light from the first channel;
a second detector that collects light from the second channel; and
a processor in electronic communication with the first detector and the second detector, wherein the processor is configured to:
receive a first measurement from the first detector and the second detector when the transparent workpiece is not present on the holding assembly;
receive a second measurement from the first detector and the second detector when the light directed at the transparent workpiece includes a periodic variation in wavelength thereby shortening a coherence length;
receive a third measurement from the first detector and the second detector when the transparent workpiece is at an angled orientation that is at an angle relative to a path of the light; and
determine thickness variation of the transparent workpiece based on the first measurement, the second measurement, and the third measurement.

8. The system of claim 7, wherein the transparent workpiece does not include an additional layer on the surface of the transparent workpiece.

9. The system of claim 7, wherein the transparent workpiece is a glass wafer.

10. The system of claim 7, wherein the light from the light source has a wavelength from ultraviolet to infrared.

11. The system of claim 7, wherein the processor is further configured to send instructions for the system to perform the first measurement, the second measurement, and the third measurement.

12. A non-transitory computer-readable storage medium, comprising one or more programs for executing the following steps on one or more computing devices:
receive a first measurement from a first detector and a second detector of an interferometer when a transparent workpiece is not present on the holding assembly and light is directed through the interferometer;
receive a second measurement from the first detector and the second detector of the interferometer when the light directed at the transparent workpiece includes a periodic variation in wavelength thereby shortening a coherence length;
receive a third measurement from the first detector and the second detector of the interferometer when the transparent workpiece is at an angled orientation that is at an angle relative to a path of the light; and
determine thickness variation of the transparent workpiece based on the first measurement, the second measurement, and the third measurement.

13. The non-transitory computer-readable storage medium of claim 12, wherein the transparent workpiece does not include an additional layer on the surface of the transparent workpiece.

14. The non-transitory computer-readable storage medium of claim 12, wherein the transparent workpiece is a glass wafer.

15. The non-transitory computer-readable storage medium of claim 12, wherein the light from the light source has a wavelength from ultraviolet to infrared.

16. The non-transitory computer-readable storage medium of claim 12, wherein the steps further include sending instructions for the interferometer to perform the first measurement, the second measurement, and the third measurement.
